(19) United States
(12) Patent Application Publication
(10) Pub. No.: US 2021/0287665 A1
(43) Pub. Date: Sep. 16, 2021

(54) VOICE RECOGNITION SYSTEM

(71) Applicant: LG ELECTRONICS INC., Seoul (KR)

(72) Inventors: Jaehong KlM, Seoul (KR); Taeho LEE, Seoul (KR); Hangil JEONG, Seoul (KR)

(73) Assignee: LG ELECTRONICS INC., Seoul (KR)

(21) Appl. No.: 17/262,371

(22) PCT Filed: Aug. 7, 2018
(86) PCT No.: PCT/KR2018/008939

§ 371 Date: Jan. 22, 2021

(30) Foreign Application Priority Data
Jul. 25, 2018 (KR) 10-2018-0086695

(51) Int. Cl. G10L 15/16; G10L 13/00; G10L 25/30; G10L 25/51; G06N 3/08

(52) U.S. Cl. CPC G10L 15/16; G10L 13/00; G06N 3/08; G10L 25/51; G10L 25/30

(57) ABSTRACT

A voice recognition system is provided. The voice recognition system according to an embodiment of the present disclosure includes a voice recognition agent configured to receive voice data from a user and transmit the voice data to an artificial intelligence server, and the artificial intelligence server configured to input the voice data to a voice recognition model, transmit a recognition result based on the voice data to the voice recognition agent, and learn the voice data. When a voice recognition rate for the voice data is lower than a preset reference, the voice recognition agent is configured to request the user for additional data for learning voice data of a user.

### TECHNICAL FIELD

The present disclosure relates to a voice recognition system that is capable of obtaining voice data or text by allowing a user to directly participate in learning of a voice recognition model and learning voice data of a user using the obtained data.

### BACKGROUND ART

Artificial intelligence is a branch of computer science and information technology for studying how computers can do the thinking, learning, and self-development that human intelligence can do, and allows computers to imitate intelligent behavior of human.

Also, artificial intelligence does not exist by itself, but is directly or indirectly related to other fields of computer science. In particular, in modern times, attempts are being made very actively to introduce artificial intelligence elements in various fields of information technology and use them to solve problems in the fields.

Meanwhile, in the related art, a context awareness technology that recognizes a user's situation using artificial intelligence and provides a user's desired information in a desired form has been actively studied.

With the development of the above-described context awareness technology, demand for a system capable of performing a function suitable for a user's situation is increasing.

Meanwhile, voice recognition systems that provide various operations and functions to users through voice recognition by combining a user's voice recognition and a context recognition technology are increasing.

Voice recognition refers to converting a voice signal into a character string or identifying linguistic meaning contents by analyzing a voice signal and combining the analyzed voice signal with a patterned database.

In the voice recognition technology, a voice recognition model analyzes input voice data, extracts features, and measures similarity with a previously collected voice model database to convert the most similar one into a text or command.

The voice recognition technology is a type of pattern recognition process. Since each person has different voice, pronunciation, and intonation, a conventional voice recognition technology collects voice data from as many people as possible, extracts common features therefrom, and generates a reference pattern.

However, since such a reference pattern configures a learning model through training data created in a laboratory environment, it is not optimized for an actual user's voice or tone.

Therefore, additional adaptive learning is required so that a voice recognition model is personalized to a user who directly uses a voice recognition device.

The present disclosure proposes a method that can increase the accuracy and efficiency of adaptive learning.

### DISCLOSURE OF THE INVENTION

### Technical Problem

The present disclosure provides a voice recognition system that is capable of obtaining voice data or text by allowing a user to directly participate in learning of a voice recognition model and learning voice data of a user using the obtained data.

### Technical Solution

According to an embodiment of the present disclosure, a voice recognition system includes a voice recognition agent configured to receive voice data from a user and transmit the voice data to an artificial intelligence server, and the artificial intelligence server configured to input the voice data to a voice recognition model, transmit a recognition result based on the voice data to the voice recognition agent, and learn the voice data, wherein, when a voice recognition rate for the voice data is lower than a preset reference, the voice recognition agent is further configured to request the user for additional data for learning voice data of a user.

In this case, the voice recognition agent may be configured to provide a specific sentence to the user, and when second voice data corresponding to the specific sentence is received, transmit the second voice data to the artificial intelligence server. The artificial intelligence server may be configured to learn the second voice data corresponding to the specific sentence.

In this case, the artificial intelligence server may be configured to transmit, to the voice recognition agent, the specific sentence corresponding to features of the voice data among a plurality of sentences based on the features of the voice data.

In this case, the plurality of sentences may be classified into a category including at least one of product function, country, region, age, dialect, gender, or foreign language, and the artificial intelligence server may be configured to transmit, to the voice recognition agent, the specific sentence included in a category requesting the user for additional learning among a plurality of categories based on the features of the voice data.

Meanwhile, the specific sentence may include a command corresponding to a function of the voice recognition agent.

Meanwhile, the voice recognition system may further include a mobile terminal. The voice recognition agent may be configured to transmit the specific sentence to the mobile terminal of the user. The mobile terminal may be configured to display text corresponding to the specific sentence.

Meanwhile, when the voice recognition rate is lower than the preset reference, the voice recognition agent may be configured to request the user to input text corresponding to the voice data.

In this case, the artificial intelligence server may be configured to store the voice data. When the text corresponding to the voice data is input, the voice recognition agent may be configured to transmit the text corresponding to the voice data to the artificial intelligence server. The artificial intelligence server may be configured to learn the stored voice data corresponding to the text.

In this case, the artificial intelligence server may be configured to convert the text into voice data, determine the stored voice data as valid data based on similarity between the converted voice data and the stored voice data, and learn the voice data determined as the valid data.

Meanwhile, the voice recognition system may further include a mobile terminal configured to receive an input of the text corresponding to the voice data and transmit the text corresponding to the voice data to the voice recognition agent.

Meanwhile, when the user inputs a specific text and third voice data corresponding to the specific text, the voice recognition agent may be configured to transmit the specific text and the third voice data corresponding to the specific text to the artificial intelligence server. The artificial intelligence server may be configured to learn the third voice data corresponding to the specific text.

Meanwhile, the voice recognition agent may be configured to provide a first option of repeating a presented voice, a second option of repeating a presented sentence, and a third option of directly writing and repeating a sentence, and request the additional data as an option having a highest voice recognition rate among the first to third options.

Meanwhile, the artificial intelligence server may be configured to learn the additional data and transmit, to the voice recognition agent, a voice recognition rate changed according to a result of learning the additional data.

According to an embodiment of the present disclosure, a voice recognition device includes an input module configured to receive voice data from a user, an artificial intelligence module configured to input the voice data to a voice recognition module, obtain a recognition result based on the voice data, and learn the voice data, wherein, when a voice recognition rate for the voice data is lower than a preset reference, the voice recognition module is configured to request the user for additional data for learning voice data of a user.

According to an embodiment of the present disclosure, an operating method of a voice recognition system include receiving, by a voice recognition agent, voice data from a user and transmitting the voice data to an artificial intelligence server, inputting, by the artificial intelligence server, the voice data to a voice recognition model, transmitting a recognition result based on the voice data to the voice recognition agent, and learning the voice data, and when a voice recognition rate for the voice data is lower than a preset reference, requesting, by the voice recognition agent, the user for additional data for learning voice data of a user.

In this case, the operation of requesting the user for the additional data for learning the voice data of the user may include providing, by the voice recognition agent, a specific sentence to the user and, when second voice data corresponding to the specific sentence is received, transmitting the second voice data to the artificial intelligence server, and learning, by the artificial intelligence server, the second voice data corresponding to the specific sentence. cl Advantageous Effects

Unlike a conventional method of passively collecting and learning voice data of a user, the present disclosure may request a voice input by presenting a sentence that can best grasp a user's voice habit, or may directly request a sentence uttered by the user as text. Therefore, according to the present disclosure, the learning performance may be remarkably improved and the rapid personalization is enabled.

### BRIEF DESCRIPTION OF THE DRAWINGS

FIG. 1 is a diagram for describing a voice recognition system according to an embodiment of the present disclosure.

FIG. 2 is a block diagram for describing a voice recognition agent related to the present disclosure.

FIG. 3 is a block diagram illustrating a configuration of an artificial intelligence server 200 according to an embodiment of the present disclosure.

FIG. 4 is a diagram for describing problems that may occur in the voice recognition system.

FIG. 5 is a diagram for describing a method of requesting a user for additional data for additional learning, according to an embodiment of the present disclosure.

FIG. 6 is a diagram for describing an operating method when option 1 or option 2 is selected, according to an embodiment of the present disclosure.

FIG. 7 is a diagram illustrating a word unit recognition rate of an uttered sentence.

FIG. 8 is a diagram for describing an operation when option 1 is selected.

FIG. 9 is a diagram for describing an operation when option 2 is selected.

FIG. 10 is a diagram for describing an operation when option 3 is selected.

FIG. 11 is a diagram for describing a method of requesting a user for additional data for additional learning, according to another embodiment of the present disclosure.

FIG. 12 is a diagram for describing an operation when a text input is requested.

FIG. 13 is a diagram for describing an operation of a voice recognition system according to an embodiment of the present disclosure.

### MODE FOR CARRYING OUT THE INVENTION

Hereinafter, embodiments will be described in detail with reference to the accompanying drawings. When describing embodiments with reference to the accompanying drawings, the same or corresponding elements are denoted by the same reference numerals. A redundant description thereof will be omitted. The suffixes “module” and “unit” for components used in the description below are assigned or mixed in consideration of easiness in writing the specification and do not have distinctive meanings or roles by themselves. Also, in relation to describing the embodiments of the present disclosure, when the detailed description of the relevant known technology is determined to unnecessarily obscure the gist of the present disclosure, the detailed description may be omitted. Also, the accompanying drawings are only for easy understanding of the embodiments disclosed in the present specification, and the technical idea disclosed in the present specification is not limited by the accompanying drawings. It will be understood as including all modifications, equivalents, and substitutes falling within the spirit and scope of the present disclosure.

The terms such as “first,” “second,” etc. are used to describe various elements, and these elements are not limited by these terms. These terms are used only for the purpose of distinguishing one element from another element.

It will be understood that when an element is referred to as being “connected with” another element, the element can be connected with the other element or intervening elements may also be present. In contrast, when an element is referred to as being “directly connected with” another element, there are no intervening elements present.

As used herein, the singular forms “a,” “an,” and “the” are intended to include the plural forms as well, unless the context clearly indicates otherwise. The terms “comprises,” “comprising,” “including,” and “having,” as used in the present disclosure are inclusive and therefore specify the presence of stated features, integers, steps, operations, elements, or components, but do not preclude the presence or addition of one or more other features, integers, steps, operations, elements, components, or combinations thereof.

A mobile terminal described herein may include a mobile phone, a smart phone, a laptop computer, a digital broadcasting terminal, a personal digital assistant (PDA), a portable multimedia player (PMP), a navigation, a slate PC, a tablet PC, an ultrabook, a wearable device (e.g., a smart watch, a smart glass, a head mounted display (HMD), etc.).

FIG. 1 is a diagram for describing a voice recognition system according to an embodiment of the present disclosure.

A voice recognition system 10 according to an embodiment of the present disclosure may include a voice recognition agent 100, an artificial intelligence server 200, and a mobile terminal 300.

The voice recognition agent 100 may communicate with the artificial intelligence server 200. In detail, the voice recognition agent 100 may provide an interface for connecting the voice recognition agent 100 to a wired/wireless network including an Internet network. The voice recognition agent 100 may transmit or receive data with a server through a connected network or another network linked to the connected network.

Also, the voice recognition agent 100 may communicate with the mobile terminal 300. In detail, the voice recognition agent 100 may provide an interface for connecting the voice recognition agent 100 to a wired/wireless network including an Internet network. The voice recognition agent 100 may transmit or receive data with the mobile terminal 300 through a connected network or another network linked to the connected network.

In addition, the voice recognition agent 100 may communicate with the mobile terminal 300 through short-range communication described with reference to FIG. 2.

Meanwhile, the voice recognition agent 100 may learn voice data in various ways or perform a function corresponding to the voice data.

For example, when the voice recognition model is mounted on the artificial intelligence server 200 and the voice recognition agent 100 receives voice data and transmits the received voice data to the artificial intelligence server 200, the artificial intelligence server 200 learns the voice data or outputs a recognition result based on the voice data and transmits the recognition result to the voice recognition agent 100, and the voice recognition agent 100 may perform control by generating a control command corresponding to the recognition result.

As another example, when the voice recognition model is mounted on the artificial intelligence server 200 and the voice recognition agent 100 receives voice data and transmits the received voice data to the artificial intelligence server 200, the artificial intelligence server 200 learns the voice data or outputs a recognition result based on the voice data and transmits a control command corresponding to the recognition result to the voice recognition agent 100.

As another example, the recognition model is mounted on the voice recognition agent 100, the voice recognition agent 100 receives voice data and learns the voice data, or outputs a recognition result based on the voice data and transmits the recognition result to the artificial intelligence server 200, and the artificial intelligence server 200 transmits a control command corresponding to the recognition result to the voice recognition agent 100.

Also, the voice recognition agent 100 may independently perform an artificial intelligence function regardless of the artificial intelligence server 200.

For example, the voice recognition model is mounted on the voice recognition agent 100, the voice recognition agent 100 receives voice data and learns the voice data, or outputs a recognition result based on the voice data, and generates a control command corresponding to the recognition result.

FIG. 2 is a block diagram for describing the voice recognition agent related to the present disclosure.

The voice recognition agent 100 may include a wireless communication module 110, an input module 120, an artificial intelligence module 130, a sensor 140, an output module 150, an interface 160, a memory 170, a controller 180, and a power supply 190.

The elements illustrated in FIG. 2 are not essential in implementing the voice recognition agent. The voice recognition agent described in the present specification may have more or fewer elements than those listed above.

In more detail, the wireless communication module 110 among the elements may include one or more modules that enable wireless communication between the voice recognition agent 100 and a wireless communication system, between the voice recognition agent 100 and another voice recognition agent 100, or between the voice recognition agent 100 and an external server. Also, the wireless communication module 110 may include one or more modules that connect the voice recognition agent 100 to one or more networks.

The wireless communication module 110 may include at least one of a broadcasting reception module 111, a mobile communication module 112, a wireless Internet module 113, a short-range communication module 114, and a location information module 115.

The input module 120 may include a camera 121 or an image input module for inputting a video signal, a microphone 122 or an audio input module for inputting an audio signal, and a user input module 123 for receiving information from a user (e.g., a touch key, a mechanical key, etc.). Voice data or image data collected by the input module 120 may be analyzed and processed by a user's control command.

The artificial intelligence module 130 is configured to process information based on artificial intelligence technology, and may include one or more modules that perform at least one of learning of information, inference of information, perception of information, or processing of natural language.

The artificial intelligence module 130 may use machine learning technology to perform at least one of learning, inference, and processing of a vast amount of information (big data) such as information stored in the voice recognition agent, environment information around the voice recognition agent, and information stored in a communicable external storage. The artificial intelligence module 130 may predict (or infer) the operation of at least one executable voice recognition agent by using the information learned using the machine learning technology, and may control the voice recognition agent so that the most feasible operation among the at least one predicted operation is executed.

The machine learning technology is a technology that collects and learns large-scale information based on at least one algorithm, and determines and predicts information based on the learned information. The learning of the information is an operation of grasping features, rules, and determination criteria of information, quantifying the relationship between pieces of information, and predicting new data using the quantified pattern.

The algorithms used by these machine learning technologies may be algorithms based on statistics. Examples of the algorithms may include a decision tree using a tree structure as a prediction model, an artificial neural network that mimics the structure and function of an organism's neural network, genetic programming based on an evolutionary algorithm of an organism, clustering that distributes observed examples into subsets, called clusters, and a Monte Carlo method that calculates function values with probability through randomly extracted random numbers.

As a branch of machine learning technology, deep learning technology is a technology that performs at least one of learning, determination, and processing of information using an artificial neural network algorithm. The artificial neural network may have a structure that connects a layer to a layer and transmits data between the layers. Such deep learning technology may learn a vast amount of information through an artificial neural network using a graphic processing unit (GPU) optimized for parallel computation.

Meanwhile, the artificial intelligence module 130 may collect (sense, monitor, extract, detect, or receive) signals, data, information, or the like that is input or output from the elements of the voice recognition agent in order to collect a vast amount of information for applying machine learning technology. Also, the artificial intelligence module 130 may collect (sense, monitor, extract, detect, or receive) data and information stored in an external storage (e.g., cloud server) connected through communication. In more detail, the collection of the information may be understood as a term including an operation of sensing information through a sensor, extracting information stored in the memory 170, or receiving information from an external storage through communication.

The artificial intelligence module 130 may sense information in the voice recognition agent, information about ambient environment surrounding the voice recognition agent, and user information through the sensor 140. Also, the artificial intelligence module 130 may receive broadcasting signals and/or broadcasting-related information, wireless signals, and wireless data through the wireless communication module 110. Also, the artificial intelligence module 130 may receive, from the input module, video information (or signals), audio information (or signals), data, or information input from a user.

The artificial intelligence module 130 may collect a vast amount of information in real time on the background, learn the collected information, and store information processed in an appropriate form (e.g., knowledge graph, command policy, personalization database, conversation engine, etc.) in the memory 170.

When the operation of the voice recognition agent is predicted based on the information learned using the machine learning technology, the artificial intelligence module 130 may control the elements of the voice recognition agent or transmit a control command for executing the predicted operation to the controller 180 in order to execute the predicted operation. The controller 180 may execute the predicted operation by controlling the voice recognition agent based on the control command.

Meanwhile, when a specific operation is performed, the artificial intelligence module 130 may analyze history information indicating the execution of the specific operation through the machine learning technology, and may update existing learned information based on this analysis information. Accordingly, the artificial intelligence module 130 may improve the accuracy of information prediction.

In the present specification, the artificial intelligence module 130 and the controller 180 may be understood as the same elements. In this case, the function performed by the controller 180 described in the present specification may be expressed as being performed by the artificial intelligence module 130. The controller 180 may be referred to as the artificial intelligence module 130. On the contrary, the artificial intelligence module 130 may be referred to as the controller 180.

Also, unlike this, in the present specification, the artificial intelligence module 130 and the controller 180 may be understood as separate elements. In this case, the artificial intelligence module 130 and the controller 180 may perform various controls on the voice recognition agent through data exchange with each other. The controller 180 may perform at least one function on the voice recognition agent or control at least one element of the voice recognition agent based on the result derived by the artificial intelligence module 130. Furthermore, the artificial intelligence module 130 may also be operated under the control of the controller 180.

The sensor 140 may include one sensor for sensing at least one of information in the voice recognition agent, information about ambient environment surrounding the voice recognition agent, or user information.

For example, the sensor 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., camera (see 121)), a microphone (see 122), a battery gauge, an environmental sensor (e.g., barometer, hygrometer, thermometer, radiation sensor, thermal detection sensor, gas detection sensor, etc.), or a chemical sensor (e.g., an electronic nose, a healthcare sensor, a biometric sensor, etc.). Meanwhile, the voice recognition agent disclosed in the present specification may combine and utilize pieces of information sensed by at least two of these sensors.

The output module 150 generates an output associated with sight, hearing, or tactile sense, and may include at least one of a display 151, an audio output module 152, a haptic module 153, or an optical output module 154. The display 151 may form a mutual layer structure with the touch sensor or may be integrally formed with the touch sensor to implement a touch screen. The touch screen may function as a user input module 123 that provides an input interface between the voice recognition agent 100 and the user and may also provide an output interface between the voice recognition agent 100 and the user.

The interface 160 serves as a passage with various types of external devices connected to the voice recognition agent 100. The interface 160 may include at least one of a wired/wireless headset port, an external charger port, a wired/wireless data port, a memory card port, a port for connecting a device equipped with an identification module, an audio input/output (I/O) port, a video I/O port, or an earphone port. The voice recognition agent 100 may perform appropriate control associated with a connected external device in response to the connection of the external device to the interface 160.

Also, the memory 170 may store data supporting various functions of the voice recognition agent 100. The memory 170 may store a large number of application programs (or applications) running in the voice recognition agent 100, data and commands for the operation of the voice recognition agent 100, and data for the operation of the artificial intelligence module 130 (e.g., at least one piece of algorithm information for machine learning, etc.). At least some of these application programs may be downloaded from an external server through wireless communication. Also, at least some of these application programs may exist on the voice recognition agent 100 from the time of shipment for the basic functions of the voice recognition agent 100 (e.g., incoming and outgoing call functions, message receiving and sending functions, etc.) Meanwhile, the application program may be stored in the memory 170, be installed on the voice recognition agent 100, and be driven by the controller 180 to perform the operation (or function) of the voice recognition agent.

In addition to the operation related to the application program, the controller 180 generally controls the overall operations of the voice recognition agent 100. The controller 180 may provide or process appropriate information or functions to the user by processing signals, data, information, or the like input or output through the above-described elements or by driving the application program stored in the memory 170.

Also, the controller 180 may control at least part of the elements described with reference to FIG. 1A so as to drive the application program stored in the memory 170. Furthermore, in order to drive the application program, the controller 180 may operate the voice recognition agent 100 by combining at least two elements included in the voice recognition agent 100 with each other.

Under the control of the controller 180, the power supply 190 receives external power and internal power and supplies the external power and the internal power to the elements included in the voice recognition agent 100. The power supply 190 includes a battery, and the battery may be an internal battery or a replaceable battery.

Hereinafter, prior to examining various embodiments implemented through the voice recognition agent 100 described above, the above-listed elements will be described in more detail with reference to FIG. 2.

First, the broadcasting reception module 111 of the wireless communication module 110 receives a broadcasting signal and/or broadcasting-related information from an external broadcasting management server via a broadcasting channel. The broadcasting channel may include a satellite channel, a ground wave channel, or the like. Two or more broadcasting reception modules may be provided to the mobile terminal 100 in order for simultaneous broadcasting reception or broadcasting channel switching for at least two broadcasting channels.

The broadcasting management server may refer to a server that generates and transmits a broadcasting signal and/or broadcasting-related information, or a server that receives a previously generated broadcasting signal and/or broadcasting-related information and transmits the previously generated broadcast signal and/or broadcasting-related information to the terminal. The broadcasting signal may include a TV broadcasting signal, a radio broadcasting signal, and a data broadcasting signal and may also include a broadcasting signal in which a data broadcasting signal is combined with a TV broadcasting signal or a radio broadcasting signal.

The broadcasting signal may be encoded according to at least one of technical standards (or broadcasting method, for example, ISO, IEC, DVB, ATSC, etc.) for transmitting or receiving digital broadcasting signals, and the broadcasting reception module 111 may receive the digital broadcasting signal by using a method suitable for the technical specification determined by the technical standards.

The broadcasting-related information may refer to information related to a broadcasting channel, a broadcasting program, or a broadcasting service provider. The broadcasting-related information may also be provided through a mobile communication network. In this case, the broadcasting-related information may be received by the mobile communication module 112.

The broadcasting-related information may exist in various forms, such as an Electronic Program Guide (EPG) of Digital Multimedia Broadcasting (DMB) or an Electronic Service Guide (ESG) of Digital Video Broadcast-Handheld (DVB-H). The broadcasting signals and/or the broadcasting-related information received through the broadcasting reception module 111 may be stored in the memory 160.

The mobile communication module 112 transmits or receives a wireless signal to or from at least one of a base station, an external terminal, and a server on a mobile communication network established according to technical standards or communication schemes for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

Examples of the wireless signal may include a voice call signal, a video call signal, or various types of data according to transmission or reception of text/multimedia messages.

The wireless Internet module 113 refers to a module for wireless Internet access, and may be embedded in the voice recognition agent 100 or provided outside the voice recognition agent 100. The wireless Internet module 113 may be configured to transmit or receive a wireless signal in a communication network based on wireless Internet technologies.

Examples of the wireless internet technology may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A). The wireless Internet module 113 transmits or receives data according to at least one wireless Internet technology in a range including Internet technologies not listed above.

Since the wireless internet connection by WiBro, HSDPA, HSUPA, GSM, CDMA, WCDMA, LTE, LTE-A, etc. is performed by mobile communication network, the wireless Internet module 113 that performs wireless Internet access through the mobile communication network may be understood as a type of the mobile communication module 112.

The short-range communication module 114 is provided for short-range communication and may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The short-range communication module 114 may support, through wireless area networks, wireless communication between the voice recognition agent 100 and the wireless communication system, between the voice recognition agent 100 and another voice recognition agent 100, or between the voice recognition agent 100 and a network where another mobile terminal 100 (or an external server) is disposed. The wireless area networks may be wireless personal area networks.

The voice recognition agent 100 may be a wearable device (e.g., a smart watch, a smart glass, a head mounted display (HMD), etc.) that is capable of exchanging data (or interworking) with the voice recognition agent 100 according to the present disclosure. The short-range communication module 114 may sense (or recognize) a wearable device capable of communicating with the voice recognition agent 100 around the voice recognition agent 100. Furthermore, when the sensed wearable device is a device authenticated to communicate with the voice recognition agent 100 according to the present disclosure, the controller 180 may transmit at least part of data processed by the voice recognition agent 100 to the wearable device through the short-range communication module 114. Accordingly, a user of the wearable device may use the data processed by the voice recognition agent 100 through the wearable device. For example, when the voice recognition agent 100 receives a call, the user may make a phone call via the wearable device, or when the voice recognition agent 100 receives a message, the user may confirm the received message via the wearable device.

The location information module 115 obtains a location (or a current location) of the voice recognition agent, and representative examples of the location information module 115 include a global positioning system (GPS) module and a Wi-Fi module. For example, when the voice recognition agent uses a GPS module, the voice recognition agent may obtain the location of the voice recognition agent by using a signal transmitted by a GPS satellite.

As another example, when the voice recognition agent uses a Wi-Fi module, the voice recognition agent may obtain the location of the voice recognition agent based on information about a wireless access point (AP) that transmits or receives a wireless signal to or from the Wi-Fi module. When necessary, the location information module 115 may alternatively or additionally perform any function among other modules of the wireless communication module 110 in order to obtain data about the location of the voice recognition agent. The location information module 115 is used to obtain the location (or the current location) of the voice recognition agent, and the location information module 115 is not limited to a module that directly calculates or obtains the location of the voice recognition agent.

Next, the input module 120 inputs video information (or signals), audio information (or signals), data, or information input from a user. For the input of the video information, the voice recognition agent 100 may include one or more cameras 121. The camera 121 processes image frames of still pictures or video obtained by image sensors in a video call mode or an image capture mode. The processed image frame may be displayed on the display 151 or stored in the memory 170. Meanwhile, a plurality of cameras 121 provided in the voice recognition agent 100 may be disposed to form a matrix structure. A plurality of pieces of image information having various angles or focuses may be input to the voice recognition agent 100 through the cameras 121 forming the matrix structure as described above. Also, the plurality of cameras 121 may be disposed in a stereo structure to obtain a left image and a right image for implementing a stereoscopic image.

The microphone 122 processes an external audio signal into electrical audio data. The processed voice data may be variously used according to the function (or the running application program) that is performed in the voice recognition agent 100. Meanwhile, various noise cancellation algorithms for cancelling noise that is generated while receiving the external audio signal may be implemented in the microphone 122.

The user input module 123 receives information from the user. When information is input through the user input module 123, the controller 180 may control the operation of the voice recognition agent 100 so as to correspond to the input information. The user input module 123 is a mechanical input module (or a mechanical key, for example, a button located on the front, rear, or side of the voice recognition agent 100, a dome switch, a jog wheel, a jog switch, etc.) and a touch-type input module. As an example, the touch-type input module may include a virtual key, a soft key, or a visual key displayed on a touch screen through software processing, or may include a touch key disposed at a portion other than the touch screen. Meanwhile, the virtual key or the visual key may be displayed on the touch screen while having various forms. For example, the virtual key may be a graphic, text, icon, video, or a combination thereof.

Meanwhile, the sensor 140 may sense at least one of information in the voice recognition agent, information about ambient environment surrounding the voice recognition agent, or user information, and may generate a sensing signal corresponding thereto. Based on the sensing signal, the controller 180 may control the driving or operation of the voice recognition agent 100, or may perform data processing, function, or operation associated with the application program installed on the voice recognition agent 100. Representative sensors among various sensors that may be included in the sensor 140 will be described in more detail.

First, the proximity sensor 141 refers to a sensor that senses the presence or absence of an object approaching a predetermined detection surface or an object existing near the proximity sensor 141 by using an electromagnetic force or infrared light, without any mechanical contact. The proximity sensor 141 may be disposed near the touch screen or in the inner area of the voice recognition agent surrounded by the touch screen as described above.

Examples of the proximity sensor include a transmission-type photoelectric sensor, a direct reflection-type photoelectric sensor, a mirror reflection-type photoelectric sensor, a high frequency oscillation-type proximity sensor, a capacity-type proximity sensor, a magnetic proximity sensor, and an infrared-type proximity sensor. When the touch screen is an electrostatic type, the proximity sensor 141 may be configured to detect the proximity of the object by a change in electric field according to the proximity of the conductive object. In this case, the touch screen (or the touch sensor) itself may be classified as the proximity sensor.

For convenience of description, the action that the object is approached while not coming into contact with the touch screen and thus the object is recognized as being located on the touch screen is referred to as “proximity touch”, and the action that the object actually comes into contact with the touch screen is referred to as “contact touch”. The location where the proximity touch of the object occurs on the touch screen refers to a location corresponding vertically to the touch screen when the object is in the proximity touch. The proximity sensor 141 may detect the proximity touch and the proximity touch pattern (e.g., a proximity touch distance, a proximity touch direction, a proximity touch speed, a proximity touch time, a proximity touch location, a proximity touch movement state, etc.).

Meanwhile, the controller 180 may process data (or information) corresponding to the proximity touch operation and the proximity touch pattern sensed by the proximity sensor 141, and may control visual information corresponding to the processed data to be displayed on the touch screen. Furthermore, the controller 180 may control the voice recognition agent 100 so that different operations or data (or information) are processed according to whether the touch to the same point on the touch screen is the proximity touch or the contact touch.

The touch sensor senses the touch (or touch input) applied to the touch screen (or the display 151) by using at least one of various touch methods such as resistive film method, a capacitive method, an infrared method, an ultrasonic method, and a magnetic field method.

As an example, the touch sensor may be configured so that a pressure applied to a specific portion of the touch screen or a change in an electrostatic capacity occurring at a specific portion of the touch screen is converted into an electrical input signal. The touch sensor may be configured to detect a location, an area, a pressure upon touch, a capacitance upon touch, and the like when a touch object applying a touch on the touch screen is touched on the touch sensor. The touch object is an object that applies a touch to the touch sensor, and may be, for example, a finger, a touch pen, a stylus pen, or a pointer.

When there is a touch input on the touch sensor, signal(s) corresponding thereto is(are) transmitted to a touch controller. The touch controller processes the signal(s) and then transmits corresponding data to the controller 180. Therefore, the controller 180 may recognize which area of the display 151 is touched. The touch controller may be an element separate from the controller 180, or may be the controller 180 itself.

Meanwhile, the controller 180 may perform different controls or the same control according to the type of the touch object that touches the touch screen (or a touch key provided in addition to the touch screen). Whether to perform different controls or the same control according to the type of the touch object may be determined according to the operation state of the voice recognition agent 100 or the running application program.

Meanwhile, the touch sensor and the proximity sensor may be implemented independently or in combination to sense various types of touches. Such touches include a short (or tap) touch, a long touch, a multi touch, a drag touch, a flick touch, a pinch-in touch, a pinch-out touch, a swipe touch, a hovering touch, and the like with respect to the touch screen.

The ultrasonic sensor may recognize location information of a sensing target by using ultrasonic waves. The controller 180 may calculate a location of a wave generating source through information sensed by an optical sensor and a plurality of ultrasonic sensors. The location of the wave generating source may be calculated by using the property that light is much faster than ultrasonic waves, that is, the time when the light reaches the optical sensor is much faster than the time when the ultrasonic waves reach the ultrasonic sensor. In more detail, the location of the wave generating source may be calculated by using the difference of the time when the ultrasonic waves arrive using light as a reference signal.

Meanwhile, the camera 121 as the element of the input module 120 may include at least one of a camera sensor (e.g., a CCD or a CMOS), a photo sensor (or an image sensor), or a laser sensor.

The camera 121 and the laser sensor may be combined with each other to sense a touch of a sensing target with respect to a 3D stereoscopic image. The photo sensor may be stacked on the display device, and the photo sensor is configured to scan a motion of a sensing target close to the touch screen. In more detail, the photo sensor scans the contents placed on the photo sensor by mounting a photo diode and a transistor (TR) in a row/column and using an electrical signal that changes according to the amount of light applied to the photo diode. That is, the photo sensor may calculate the coordinates of the sensing target according to the change amount of light, and may obtain location information of the sensing target based on the coordinates of the sensing target.

The display 151 displays (outputs) information processed by the voice recognition agent 100. For example, the display 151 may display execution screen information of the application program driven by the voice recognition agent 100, or user interface (UI) or graphic user interface (GUI) information according to the execution screen information.

Also, the display 151 may be configured as a three-dimensional display that displays a three-dimensional image. A three-dimensional display method, such as a stereoscopic method (glasses method), an auto stereoscopic method (glassless method), and a projection method (holographic method) may be applied to the three-dimensional display.

In general, a 3D stereoscopic image includes a left image (a left-eye image) and a right image (a right-eye image). Depending on a method by which the left and right images are combined into a 3D stereoscopic image, there are a top-down method of arranging the left and right images up and down in one frame, an L-to-R (left-to-right, side by side) method of placing the left and right images left and right in one frame, a checker board method of arranging pieces of the left and right images in a tile form, an interlaced method of alternately arranging the left and right images in columns or rows, and a time sequential (frame by frame) method of alternately displaying the left and right images by time.

Also, a 3D thumbnail image may generate a left image thumbnail and a right image thumbnail from the left image and the right image of the original image frame, respectively, and may combine the left image thumbnail and the right image thumbnail to generate one image. In general, the thumbnail refers to a reduced image or a reduced still picture. The left image thumbnail and the right image thumbnail generated in this way are displayed with a left and right distance difference on the screen as much as a depth corresponding to parallax between the left image and the right image, thereby representing a three-dimensional sense of space.

The left image and the right image required for realization of a 3D stereoscopic image may be displayed on a stereoscopic display by a stereoscopic processor. The stereoscopic processor receives a 3D image (an image at a reference point of view and an image at an extended point of view) and sets a left image and a right image therefrom, or receives a 2D image and converts the 2D image into a left image and a right image.

The audio output module 152 may output audio data received from the wireless communication module 110 or stored in the memory 170 in a call signal reception mode, a call mode or a record mode, a voice recognition mode, and a broadcasting reception mode. The audio output module 152 may output audio signals related to the functions (e.g., call signal reception sound, message reception sound, etc.) performed by the voice recognition agent 100. The audio output module 152 may include a receiver, a speaker, and a buzzer.

The haptic module 153 generates various tactile effects that a user may feel. A typical example of the haptic effects generated by the haptic module 153 is vibration. The intensity, pattern, and the like of vibration generated by the haptic module 153 may be controlled according to a user's selection or settings of the controller. For example, the haptic module 153 may synthesize different vibrations and output a result of the synthesis, or may sequentially output the different vibrations.

Besides vibration, the haptic module 153 may generate various other tactile effects, including an effect by stimulation such as a pin arrangement vertically moving to contact skin, a spray force or suction force of air through a jet orifice or a suction opening, a touch to the skin, a contact of an electrode, or electrostatic force, an effect by reproducing the sense of cold and warmth using an element that can absorb or generate heat, and the like.

The haptic module 153 may transmit a tactile effect through direct contact, and may also be implemented such that a user may feel a tactile effect through a muscle sense of a finger, an arm, or the like. Two or more haptic modules 153 may be provided according to the particular configuration of the voice recognition agent 100.

The optical output module 154 outputs a signal for notifying the occurrence of an event by using light emitted from a light source of the voice recognition agent 100. Examples of the event generated in the voice recognition agent 100 may include message reception, call signal reception, missed call, alarm, schedule notification, email reception, and information reception through applications.

The signal output by the optical output module 154 is implemented as the HMD emits light of a single color or a plurality of colors to the front or rear surface. The signal output may be terminated when the voice recognition agent detects the user's event confirmation.

The interface 160 serves as a passage with any external devices connected to the voice recognition agent 100. The interface 160 may receive data from the external device, may receive power and transmit the power to each element of the voice recognition agent 100, or may transmit internal data of the voice recognition agent 100 to the external device. For example, the interface 160 may include a wired/wireless headset port, an external charger port, a wired/wireless data port, a memory card port, a port for connecting a device equipped with an identification module, an audio I/O port, a video I/O port, and an earphone port.

Meanwhile, the identification module is a chip storing a variety of information for authenticating usage authority of the voice recognition agent 100 and may include a user identity module (UIM), a subscriber identity module (SIM), and a universal subscriber identity module (USIM). The device equipped with the identification module (hereinafter, referred to as an identification device) may be manufactured in a smart card form. Accordingly, the identification device may be connected to the voice recognition agent 100 through the interface 160.

Also, when the voice recognition agent 100 is connected to an external cradle, the interface unit 160 may become a passage through which power from the cradle is supplied to the voice recognition agent 100, or may become a passage through which various command signals input from the cradle by the user are transmitted to the voice recognition agent 100. The various command signals or the power input from the cradle may be operated as signals for recognizing that the voice recognition agent 100 is correctly mounted on the cradle.

The memory 170 may store a program for the operation of the controller 180 and may temporarily store input/output data (e.g., a phone book, a message, a still picture, a video, etc.). The memory 170 may store data about various patterns of vibrations and sounds output during the touch input on the touch screen.

The memory 170 may include at least one type of storage medium selected from among a flash memory type, a hard disk type, a solid state disk (SSD) type, a silicon disk drive (SDD) type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. The voice recognition agent 100 may operate in relation to a web storage that performs a storage function of the memory 170 on Internet.

As described above, the controller 180 controls the operation related to the application program and the overall operations of the voice recognition agent 100. For example, when the state of the voice recognition agent satisfies a set condition, the controller 180 may execute or release a lock state that restricts input of a user's control command to applications.

Also, the controller 180 may perform control and processing related to the voice call, data communication, and video call, or may perform pattern recognition processing for recognizing handwriting input or drawing input on the touch screen as a text and an image, respectively. Furthermore, in order to implement various embodiments described below on the voice recognition agent 100 according to the present disclosure, the controller 180 may control any one or a combination of the elements described above.

Under the control of the controller 180, the power supply 190 receives external power or internal power and supplies power necessary for the operation of each element. The power supply 190 may include a battery, and the battery may be a rechargeable internal battery, or may be detachably connected to a terminal body for the purpose of charging or the like.

Also, the power supply 190 may include a connection port. The connection port may be configured as an example of the interface 160 to which an external charger for supplying power to charge the battery is electrically connected.

As another example, the power supply 190 may be configured to charge the battery in a wireless manner without using a connection port. In this case, the power supply 190 may receive power from an external wireless power transmission device by using at least one of an inductive coupling method based on a magnetic induction phenomenon or a magnetic resonance coupling method based on an electromagnetic resonance phenomenon.

Meanwhile, various embodiments may be implemented within a recording medium readable by a computer or a similar device by using software, hardware, or combination thereof.

Meanwhile, the description of the voice recognition agent 100 described above with reference to FIG. 2 may be equally applied to the mobile terminal 300.

In the present disclosure, the term “memory 170” may also be referred as the “storage 170”.

Meanwhile, the controller 180 may control the operation of each element of the mobile terminal 100 under the control of the artificial intelligence module 130.

Meanwhile, the input module 120 of the mobile terminal 100 may include the sensor 140 and may perform all functions performed by the sensor 140. For example, the input module 120 may sense a user touch input.

FIG. 3 is a block diagram illustrating the configuration of the artificial intelligence server 200 according to an embodiment of the present disclosure.

The communication module 210 may communicate with an external device.

In detail, the communication module 210 may be connected to the voice recognition agent 100 to transmit or receive data to or from the voice recognition agent 100 under the control of the artificial intelligence module 220.

Also, the communication module 210 may be connected to the mobile terminal 300 to transmit or receive data to or from the mobile terminal 300 under the control of the artificial intelligence module 220.

In the present specification, when data transmitted from the artificial intelligence server 200 is finally transmitted to the mobile terminal 300, such data may be transmitted through the voice recognition agent 100 or may be directly transmitted to the mobile terminal 300 without passing through the voice recognition agent 100.

Also, in the present specification, when data transmitted from the mobile terminal 300 is finally transmitted to the artificial intelligence server 200, such data may be transmitted through the voice recognition agent 100 or may be directly transmitted to the artificial intelligence server 200 without passing through the voice recognition agent 100.

The artificial intelligence module 220 may receive voice data from the voice recognition agent 100 through the communication module 210.

Also, the voice recognition module 222 included in the artificial intelligence module 220 may output a recognition result based on voice data by using the voice recognition model, may transmit the output recognition result to the voice recognition agent, or may transmit a control command corresponding to the output recognition result to the voice recognition agent.

Also, the voice recognition module 222 included in the artificial intelligence module 220 may adaptively learn voice data and store the learning result in the voice data database 232 in the storage 230.

Also, the voice recognition module 222 included in the artificial intelligence module 220 may label voice data in a sentence or word and store the labeling result in the voice data database 232.

Meanwhile, the artificial intelligence module 220 may analyze the voice signal by using the voice recognition model and may extract features to extract the recognition result. The recognition result may indicate whether the received voice signal is a command or a non-command, or which one of a plurality of commands the received voice signal means.

The command may be a command previously registered so that the voice recognition agent or other device connected to the voice recognition agent performs a specific function, and the non-command may be a command that is not related to the execution of a specific function.

Meanwhile, a sentence recommendation module 221 included in the artificial intelligence module 220 may analyze features of voice data by using a voice feature analysis model.

Meanwhile, the sentence database 231 in the storage 230 may hold a plurality of categorized sentences.

The sentence recommendation module 221 included in the artificial intelligence module 220 may search for a specific sentence corresponding to the features of the voice data among the plurality of sentences held by the sentence database 231, and may transmit the found specific sentence to the voice recognition agent.

Meanwhile, in this drawing, the sentence recommendation module 221, the voice recognition module 222, the sentence database 231, and the voice database 232 have been described as constituting one server, but the present disclosure is not limited thereto, and various combinations may be possible.

For example, the sentence recommendation module 221 and the sentence database 231 may constitute a first server, and the voice recognition module 222 and the voice database 232 may constitute a second server. In this case, the first server and the second server may transmit or receive data with each other.

FIG. 4 is a diagram for describing problems that may occur in the voice recognition system.

Existing products collect data from multiple users, relearn the voice recognition model based on big data collected in the cloud, and upgrade the voice recognition software to improve the performance of the voice recognition model.

However, since human voices/tones are so diverse, a voice recognition model has to be optimized and learned for a specific user in order to increase a recognition rate.

When such an optimization process does not exist, recognition failure is repeated as illustrated in FIG. 4, and thus it may negatively affect products and brands.

Therefore, it is necessary for the user using the voice recognition agent to directly learn his or her own voice.

FIG. 5 is a diagram for describing a method of requesting a user for additional data for additional learning, according to an embodiment of the present disclosure.

The voice recognition agent 100 may receive voice data from a user (S505).

Also, the voice recognition agent 100 may transmit the received voice data to the artificial intelligence server (S510).

Meanwhile, the artificial intelligence server 200 may receive voice data, may input the received voice data to the voice recognition model, and may output at least one of a voice recognition rate or a recognition result based on the voice data (S515).

The voice recognition rate may be measured by comparing confidence scores for voice.

In detail, the artificial intelligence server 200 may calculate a confidence score of voice data of a user compared to an average of test data learned in the manufacturing process or confidence scores extracted from the currently personalized voice data.

For example, when the average of the confidence scores of voice data previously learned for a specific command or a wakeup word is 70.02 and the confidence score of the voice data uttered by a specific user is 52.13, the recognition rate may be calculated as about 74%.

Also, the recognition rate may be obtained by comparing an error with a sample and then obtaining an average value.

For example, the recognition rate for the voice data of the user may be calculated by extracting a specific number of samples from among voice data previously learned for a specific command or a wakeup word and calculating a mean square error (MSE) or a root mean square error (RMSE) between the voice data uttered by a specific user and the samples.

Meanwhile, the artificial intelligence server 200 may transmit the obtained voice recognition rate to the voice recognition agent 100 (S520).

Meanwhile, the voice recognition agent 100 may receive the voice recognition rate for the voice data, and may request the user for additional data for learning the voice data of the user when the voice recognition rate is lower than a preset reference.

In more detail, the voice recognition agent 100 may output an inquiry for additional learning of the voice recognition model in order to obtain additional data (S525). In this case, the voice recognition agent 100 may output the voice recognition rate for the voice data of the user together.

For example, the voice recognition agent 100 may output a voice message “As a result of grasping the voice recognition rate, my recognition rate for your voice is about 60%.—Would you like to optimize my voice recognition function for your voice?”.

Meanwhile, when an input of acceptance for additional learning is received, the voice recognition agent 100 may provide a plurality of options for additional learning (S530).

In detail, the voice recognition agent may provide the user with a first option of repeating a presented voice, a second option of repeating a presented sentence, and a third option of directly writing and repeating a sentence.

Meanwhile, when an input of selecting a specific option is received from the user (S535), the voice recognition agent may request the user for additional data corresponding to the selected option.

FIG. 6 is a diagram for describing an operating method when option 1 or option 2 is selected, according to an embodiment of the present disclosure.

The voice recognition agent 100 may transmit, to the artificial intelligence server 200, a request for a sentence for additional learning (S605).

Meanwhile, when the request for the sentence is received (S610), the artificial intelligence server 200 may analyze the features of the voice data (S615).

Also, the artificial intelligence server 200 may search for a specific sentence corresponding to the features of the voice data among the plurality of sentences based on the features of the voice data (S620).

In detail, the plurality of sentences may be stored in the sentence database 231, and the plurality of sentences may be classified by category. The category may include at least one of product function, country, region, intonation, age, dialect, gender, or foreign language.

Also, the artificial intelligence server 200 may calculate a recognition rate of words included in the voice data of the user.

For example, referring to FIG. 7, when the user utters the sentence “Can you tell me how many water bottle do we have?”, the artificial intelligence server 200 may calculate a confidence score in units of words included in a sentence, and obtain a specific word (water, bottle) having a confidence score lower than a preset reference.

The artificial intelligence server may obtain the features of the voice data based on the recognition rate of words and the features of words included in the voice data of the user.

For example, when the recognition rate of specific words (water, bottle) is low and specific words (water, bottles) have the features that American English and British English are pronounced differently, the artificial intelligence server may obtain the features of the voice data that the recognition rate of words that are pronounced differently depending on whether the user's origin is American or British is low.

In this case, the artificial intelligence server may determine that additional learning is required for the country category among the plurality of categories, based on the features of the voice data.

The artificial intelligence server may obtain a specific sentence included in the category requesting the user for additional learning among the plurality of categories, based on the features of the voice data.

For example, a plurality of sentences including words that may distinguish the user's country of origin may be classified into the country category. The artificial intelligence server may obtain a sentence including words that may be learned by classifying British English and American English among the plurality of sentences.

For example, “schedule” may have the features that are pronounced differently in American English and British English. Therefore, the artificial intelligence server may obtain the sentence “Can you tell me my schedule of today?” in the country category.

As another example, “water” and “bottle” may have different pronunciation features in American English and British English. Therefore, the artificial intelligence server may obtain a sentence “Can you tell me how many water bottle do we have?” in the country category.

That is, the word included in the obtained sentence may have the same meaning and letter, but may be a word that may be pronounced with various pronunciations or various intonations.

Also, words included in a sentence corresponding to a specific category may have the same meaning and letter, but may be words that may be pronounced with various pronunciations or various intonations depending on the features of the categories (country, region, etc.).

As another example, the user had the intention of “Will you play some quiet music?”, but uttered the sentence “Would you like to play a quiet masic?” since the user is from a specific region (Gyeongsang-do).

In this case, the artificial intelligence server 200 may calculate a recognition rate of words included in the voice data of the user, and obtain a specific word (music) whose recognition rate is lower than a preset reference.

The artificial intelligence server may obtain the features of the voice data based on the recognition rate of words and the features of words included in the voice data of the user.

For example, when the recognition rate of a specific word (music) is low and a specific word (music) has the features that the specific word is pronounced uniquely in a specific region (Gyeongsang-do), the artificial intelligence server may obtain the features of voice data that the recognition rate of words that are pronounced differently in Gyeongsang-do is low.

In this case, the artificial intelligence server may determine that additional learning is required for the region category among the plurality of categories, based on the features of the voice data.

The artificial intelligence server may obtain a specific sentence included in the category requesting the user for additional learning among the plurality of categories, based on the features of the voice data.

For example, a plurality of sentences including words that may distinguish the user's region of origin may be classified into the region category. The artificial intelligence server may obtain a sentence including words capable of learning that he or she is from the Gyeongsang-do region among the plurality of sentences.

For example, “rice” may have a feature that “rise” is pronounced as “reise” in Gyeongsang-do. Therefore, the artificial intelligence server may obtain a sentence “How much rice is left in the house?” from the regional category.

That is, the words included in the sentence corresponding to the region category may have the same meaning and letter, but may be words that may be pronounced with various pronunciations or various intonations depending on the region.

In addition, sentences related to the product function may be classified into a product function category. In this case, the sentence related to the product function may include a command corresponding to a function performed by the voice recognition agent or another device interlocked with the voice recognition agent.

For example, sentences such as “Will you tell me how many minutes are left to dehydrate in the washing machine?” and “Would you like to increase the air conditioner temperature to 24° C?” may be classified into the product function category.

When the voice data of the user has the features that the recognition rate for the command is low, the artificial intelligence server may extract the sentences from the product function category.

Also, words included in the sentence corresponding to the age category may have the same meaning and letter, but may be words that may be pronounced with various pronunciations or various intonations depending on age.

Also, words included in the sentence corresponding to the gender category may have the same meaning and letter, but may be words that may be pronounced with various pronunciations or various intonations depending on gender.

Also, words included in the sentence corresponding to the dialect category may have the same meaning and letter, but may be words that may be pronounced with various pronunciations or various intonations depending on dialect.

Also, words included in the sentence corresponding to the foreign language category may have the same meaning and letter, but may be words that may be pronounced with various pronunciations or various intonations depending on foreign language.

Meanwhile, in addition to extracting the features from the voice data, the artificial intelligence server 200 may obtain the features of the voice data based on personal information previously registered by the user.

For example, the user may register personal information such as country, gender, age, region, and dialect. When the user has registered personal information that the country of origin is the UK, the artificial intelligence server may determine that additional learning for the country category is required, and may obtain a sentence including words that may be learned by distinguishing British English and American English.

Meanwhile, the specific sentence obtained by the artificial intelligence server may include a command corresponding to the function of the voice recognition agent.

The function of the voice recognition agent may include a function provided by a device interworking with the voice recognition agent as well as a function provided by the voice recognition agent itself.

Since the specific sentence includes not only a word for learning the user's country, region, age, etc., but also a command to be uttered directly by the user, the artificial intelligence server may collect voice data corresponding to the command.

Meanwhile, the specific sentence obtained by the artificial intelligence server may include a wakeup word for calling the voice recognition agent.

The artificial intelligence server may improve the recognition rate for the wakeup word by separately extracting and learning only the wakeup word from among second voice data uttered by the user in response to the specific sentence.

Meanwhile, the artificial intelligence server may transmit the obtained specific sentence to the voice recognition agent (S625).

Meanwhile, when additional learning is required, the process of transmitting the specific sentence may be performed without S520 to S535 and S605.

In detail, when voice data is received, the artificial intelligence server 200 may analyze the features of the voice data and obtain the recognition rate of the voice data. Also, when the recognition rate of voice data is lower than the preset reference, the artificial intelligence server 200 may search for a specific sentence corresponding to the features of the voice data and transmit the found sentence to the voice recognition agent 100.

Meanwhile, the voice recognition agent 100 may output the received specific sentence (S630).

In detail, as illustrated in FIG. 8, when the user selects the first option of repeating the presented voice, the voice recognition agent may output the received specific sentence as the voice signal.

Also, when the user selects the second option of repeating the presented sentence, as illustrated in FIG. 9, the voice recognition agent may transmit the specific sentence to the user's mobile terminal 300.

In this case, the user's mobile terminal 300 may display text corresponding to the specific sentence.

Meanwhile, when the user utters the specific sentence, the voice recognition agent may receive second voice data corresponding to the uttered specific sentence (S635) and may transmit the received second voice data to the artificial intelligence server 200 (S640).

Meanwhile, when the second voice data corresponding to the specific sentence is received, the artificial intelligence server 200 may learn the second voice data corresponding to the specific sentence (S645).

The artificial intelligence server may hold the voice data before learning the second voice data. When the second voice data is received, the audio data before learning the second audio data is used as source data, and the second audio data is used as target data. The source data may be adaptively learned according to the target data.

Also, the artificial intelligence server may label the specific sentence on the second voice data and store it in the voice database 232. The voice database 232 is a database personalized to a specific user and may be used to recognize the voice of the specific user.

In this case, the voice recognition model may be updated by reflecting the learning result. The artificial intelligence server may transmit the voice recognition rate changed according to the result of learning the additional data (S650).

In detail, the artificial intelligence server may re-input the voice data received in operation 510 to the updated voice recognition model, and may calculate the recognition rate and transmit the calculated recognition rate to the voice recognition agent.

Meanwhile, when the changed recognition rate is received, the voice recognition agent may output the changed recognition rate (S655).

For example, the voice recognition agent may output a message “As a result of learning my algorithm based on the voice data provided by the customer, the learning rate has improved from 60% to 70%.”

Meanwhile, an embodiment in which a user directly writes a sentence and selects the third option of repeating will be described with reference to FIG. 10.

When the user inputs a specific text and third voice data corresponding to the specific text, the voice recognition agent may transmit the specific text and the third voice data corresponding to the specific text to the artificial intelligence server.

In detail, at least one of the mobile terminal 300 and the voice recognition agent 100 may receive a user's text input and voice data corresponding to the input text.

In this case, the voice recognition agent may transmit the received text and the received voice data corresponding to the text to the artificial intelligence server.

In this case, the artificial intelligence server may learn the third voice data corresponding to the specific text.

In detail, the artificial intelligence server may determine words included in the text and voice data corresponding to the words. The artificial intelligence server may learn the voice data corresponding to the words.

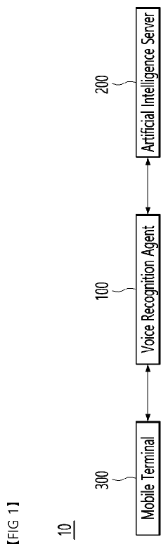

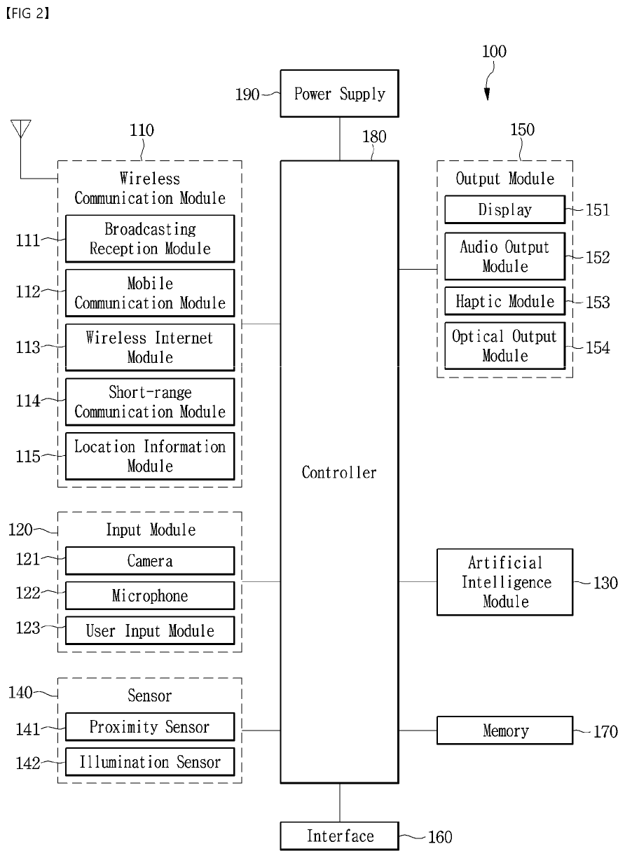

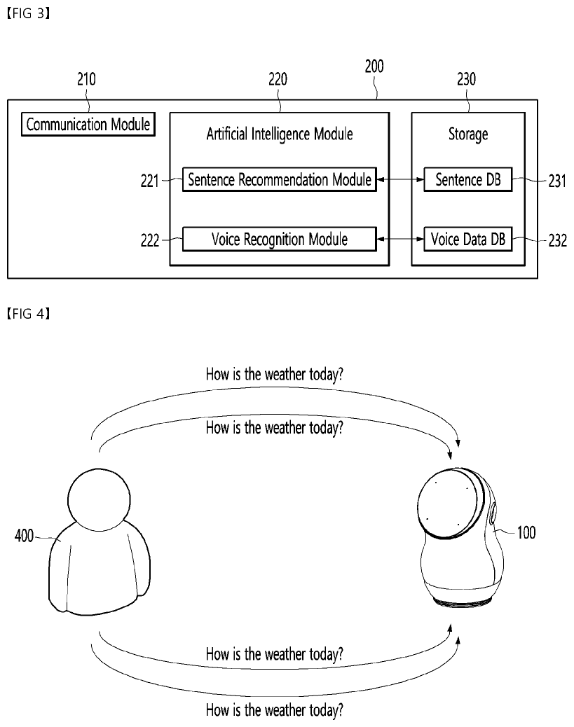

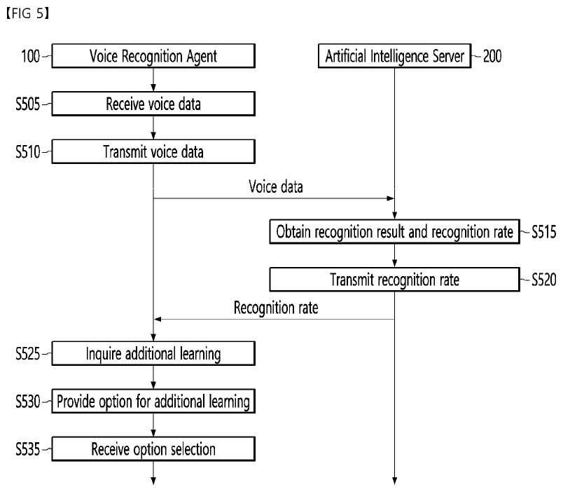

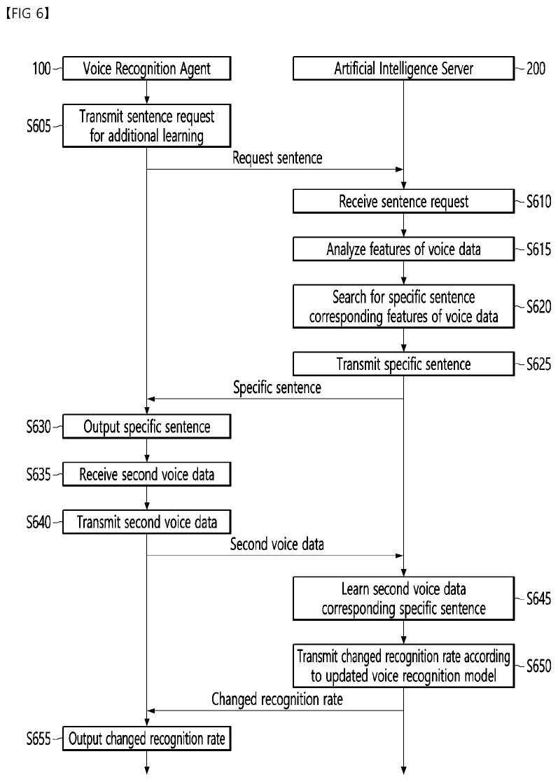

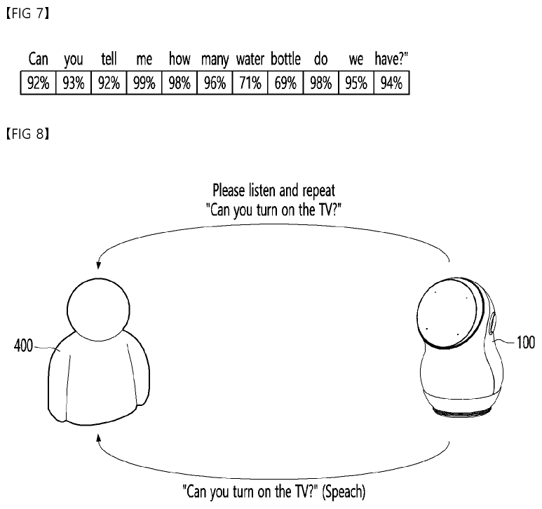

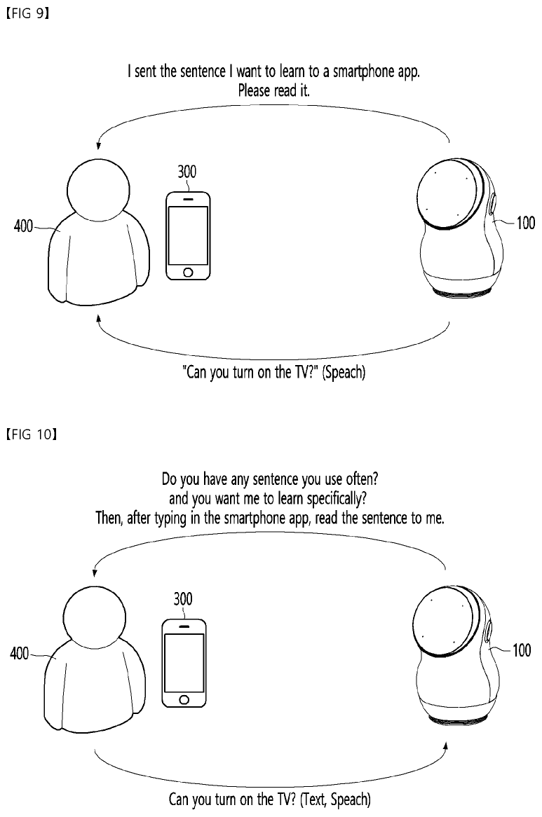

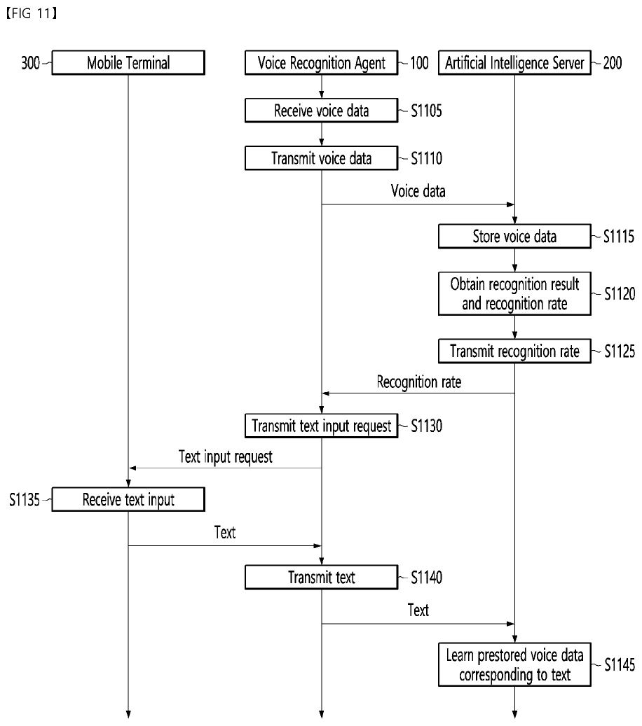

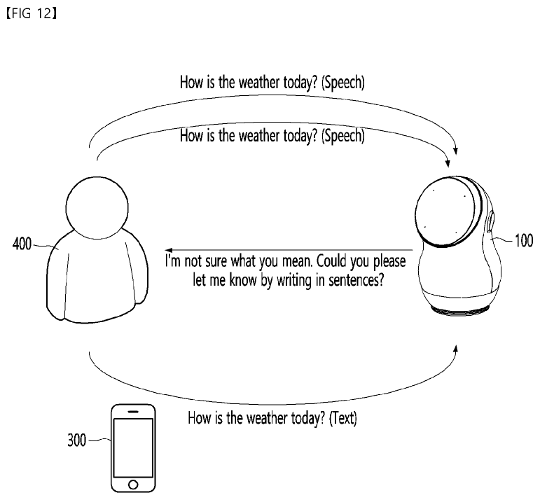

FIG. 11 is a diagram for describing a method of requesting a user for additional data for additional learning, according to another embodiment of the present disclosure.

The voice recognition agent 100 may receive voice data from a user (S1105).

Also, the voice recognition agent 100 may transmit the received voice data to the artificial intelligence server (S1110).

Meanwhile, the artificial intelligence server 200 may receive voice data and store the received voice data in the storage (S1115).

Also, the artificial intelligence server 200 may input the voice data to the voice recognition model, and may output at least one of a voice recognition rate or a recognition result based on the voice data (S1120).

Meanwhile, the artificial intelligence server 200 may transmit the obtained voice recognition rate to the voice recognition agent 100 (S1125).

Meanwhile, the voice recognition agent 100 may receive the voice recognition rate for the voice data, and may request additional data for learning the user's voice from the user when the voice recognition rate is lower than a preset reference.

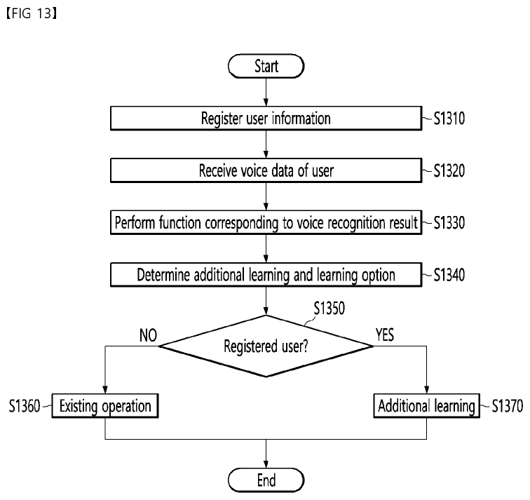

Specifically, as illustrated in FIG. 12, when the voice recognition rate is lower than the preset reference, the voice recognition agent 100 may transmit a text input request corresponding to the previously received voice data to the mobile terminal 300 (S1130).

Meanwhile, the mobile terminal 300 may receive, from the user, an input of text corresponding to the voice data uttered by the user (S1135), and may transmit the received text to the voice recognition agent (S1135).

In this case, the voice recognition agent 100 may transmit the received text to the artificial intelligence server 200 (S1140).

Meanwhile, although it has been described that the text transmitted from the mobile terminal 300 is transmitted to the artificial intelligence server through the voice recognition agent, the present disclosure is not limited thereto. For example, the mobile terminal 300 may directly transmit text to the artificial intelligence server.

In this case, the artificial intelligence server may learn the prestored voice data corresponding to the text (S1145).

In detail, the artificial intelligence server may convert the received text into voice data by using Text To Speech (TTS). The artificial intelligence server may calculate the similarity by comparing the metric of the prestored voice data and the metric of the converted voice data, and may determine the prestored voice data as valid data based on the similarity between the prestored voice data and the converted voice data.

When the prestored voice data is determined as valid data, the artificial intelligence server may label the voice data determined as valid data with text and store it in the voice data database 232.

On the other hand, the learning of voice data may be implemented by learning the TTS to output the voice and then learning the voice recognition model when a user's acceptance request is received.

In detail, the artificial intelligence server may learn the TTS from the voice data of the user. The artificial intelligence server may generate and transmit voice data similar to the user's voice by using the learned TTS. The voice recognition agent may output the voice data generated by the TTS.

In this case, the user may determine whether the voice generated by the TTS is similar to his or her voice, and may receive the acceptance request when the voice is similar to his or her voice.

In this case, the voice recognition agent may transmit the acceptance request to the artificial intelligence server, and the artificial intelligence server may update the voice recognition model by learning the voice data learned in the TTS.

Also, when the user who determines that the voice generated by the TTS is not similar to his or her voice inputs a rejection request, the voice recognition agent may request the user again for additional data for learning the voice data of the user.

Meanwhile, the text request for additional learning may be performed when the voice recognition fails repeatedly.

For example, when the voice recognition agent fails to recognize the same word or sentence more than a preset number of times, or when the recognition rate is lower than the preset reference more than a preset number of times, the voice recognition agent may request the user to input text corresponding to the previously uttered voice data.

As another example, the voice recognition agent primarily performs learning by presenting a specific sentence to the user and requesting the user to repeat the specific sentence in the same manner as described with reference to FIG. 6, an when the user's voice is still not recognized, the voice recognition agent may request the user for text for additional learning.

FIG. 13 is a diagram for describing the operation of the voice recognition system according to an embodiment of the present disclosure.

The voice recognition system may receive user information from a user and register the received user information (S1310).

In detail, the voice recognition agent may receive the user information and transmit the received user information to the server, and the server may store the received user information.

The user information may include at least one of country, region, intonation, age, or gender.

Meanwhile, the voice recognition system may receive the voice data of the user, recognize the voice data, and perform the function corresponding to the voice recognition result (S1320, S1330).

Meanwhile, the voice recognition system may determine whether the user participates in additional learning and may determine a learning option (S1340).

In detail, the voice recognition agent may output an inquiry for additional learning and provide a plurality of options for the additional learning method.

When an input of accepting additional learning and selecting a specific option is received from the user, the voice recognition system may register the selected option. When additional learning is required later, the voice recognition system may perform additional learning with the registered option.

Meanwhile, since an option for better learning may differ depending on the user, the voice recognition agent may perform learning with all of the plurality of options and then register an option having a high voice recognition rate after learning.

For example, when the recognition rate of the second option is the highest among the first option of repeating the presented voice, the second option of repeating the presented sentence, and the third option of writing and repeating the direct sentence, the voice recognition system may request the user for additional data as the second option having the highest voice recognition rate.

Meanwhile, the criteria of the voice recognition rate for performing a specific function may be different depending on what the specific function is.

For example, a home voice-based service having commands such as “turn on” and “turn off” may perform a function corresponding to a user's command as long as the voice recognition rate is 55% or higher.

As another example, a command for checking a user's personal message may perform a function corresponding to a user's command only when the voice recognition rate is 65% or higher.

As another example, a command for payment or authentication may perform a function corresponding to a user's command only when the voice recognition rate is 75% or higher.

Meanwhile, the present disclosure has been described above as being implemented by the voice recognition agent, the artificial intelligence server, and the mobile terminal, but is not limited thereto.

For example, all the configurations and functions of the artificial intelligence server described above may be mounted on the voice recognition agent and performed thereon.

Unlike the conventional method of passively collecting and learning the voice data of the user, the present disclosure may request a voice input by presenting a sentence that can best grasp a user's voice habit, or may directly request a sentence uttered by the user as text. Therefore, according to the present disclosure, the learning performance may be remarkably improved and the rapid personalization is enabled.

On the other hand, the controller 180 is generally a component that manages the control of the device and may also be referred to as a central processing unit, a microprocessor, a processor, and the like.

The present disclosure may be embodied as computer-readable codes on a program-recorded medium. The computer-readable recording medium may be any recording medium that stores data which can be thereafter read by a computer system. Examples of the computer-readable medium may include hard disk drive (HDD), solid state disk (SSD), silicon disk drive (SDD), read-only memory (ROM), random-access memory (RAM), CD-ROM, a magnetic tape, a floppy disk, and an optical data storage device. Also, the computer-readable medium may include a carrier wave (for example, transmission over the Internet). In addition, the computer may include the controller 180 of the terminal. Accordingly, the above detailed description should not be construed as being restrictive in all respects and should be considered illustrative. The scope of the present specification should be determined by rational interpretation of the appended claims, and all changes within the equivalent scope of the present specification fall within the scope of the present specification.

1. A voice recognition system comprising:
a voice recognition agent configured to
receive voice data from a user and transmit the voice data to an artificial intelligence server; and
the artificial intelligence server configured to
input the voice data to a voice recognition model, transmit a recognition result based on the voice data to the voice recognition agent, and learn the voice data,
wherein, when a voice recognition rate for the voice data is lower than a preset reference, the voice recognition agent is further configured to request the user for additional data for learning voice data of a user.

2. The voice recognition system according to claim 1, wherein the voice recognition agent is configured to:
provide a specific sentence to the user; and
when second voice data corresponding to the specific sentence is received, transmit the second voice data to the artificial intelligence server, and
wherein the artificial intelligence server is configured to learn the second voice data corresponding to the specific sentence.

3. The voice recognition system according to claim 2, wherein the artificial intelligence server is configured to transmit, to the voice recognition agent, the specific sentence corresponding to features of the voice data among a plurality of sentences based on the features of the voice data.

4. The voice recognition system according to claim 3, wherein the plurality of sentences are classified into a category including at least one of product function, country, region, age, dialect, gender, or foreign language, and
wherein the artificial intelligence server is configured to transmit, to the voice recognition agent, the specific sentence included in a category requesting the user for additional learning among a plurality of categories based on the features of the voice data.

5. The voice recognition system according to claim 3, wherein the specific sentence includes a command corresponding to a function of the voice recognition agent.

6. The voice recognition system according to claim 2, wherein the voice recognition system further comprises a mobile terminal,
wherein the voice recognition agent is configured to transmit the specific sentence to the mobile terminal of the user, and
wherein the mobile terminal is configured to display text corresponding to the specific sentence.

7. The voice recognition system according to claim 1, wherein, when the voice recognition rate is lower than the preset reference, the voice recognition agent is configured to request the user to input text corresponding to the voice data.

8. The voice recognition system according to claim 7, wherein the artificial intelligence server is configured to store the voice data,
wherein, when the text corresponding to the voice data is input, the voice recognition agent is configured to transmit the text corresponding to the voice data to the artificial intelligence server, and
wherein the artificial intelligence server is configured to learn the stored voice data corresponding to the text.

9. The voice recognition system according to claim 8, wherein the artificial intelligence server is configured to convert the text into voice data, determine the stored voice data as valid data based on similarity between the converted voice data and the stored voice data, and learn the voice data determined as the valid data.

10. The voice recognition system according to claim 8, wherein the voice recognition system further comprises a mobile terminal configured to receive an input of the text corresponding to the voice data and transmit the text corresponding to the voice data to the voice recognition agent.

11. The voice recognition system according to claim 1, wherein, when the user inputs a specific text and third voice data corresponding to the specific text, the voice recognition agent is configured to transmit the specific text and the third voice data corresponding to the specific text to the artificial intelligence server, and
wherein the artificial intelligence server is configured to learn the third voice data corresponding to the specific text.

12. The voice recognition system according to claim 1, wherein the voice recognition agent is configured to:
provide a first option of repeating a presented voice, a second option of repeating a presented sentence, and a third option of directly writing and repeating a sentence; and
request the additional data as an option having a highest voice recognition rate among the first to third options.

13. The voice recognition system according to claim 1, wherein the artificial intelligence server is configured to learn the additional data and transmit, to the voice recognition agent, a voice recognition rate changed according to a result of learning the additional data.

14. An operating method of a voice recognition system, the operating system comprising:
receiving, by a voice recognition agent, voice data from a user and transmitting the voice data to an artificial intelligence server;
inputting, by the artificial intelligence server, the voice data to a voice recognition model, transmitting a recognition result based on the voice data to the voice recognition agent, and learning the voice data; and
when a voice recognition rate for the voice data is lower than a preset reference, requesting, by the voice recognition agent, the user for additional data for learning voice data of a user.

15. The operating method according to claim 14, wherein the operation of requesting the user for the additional data for learning the voice data of the user comprises:
providing, by the voice recognition agent, a specific sentence to the user and, when second voice data corresponding to the specific sentence is received, transmitting the second voice data to the artificial intelligence server; and
learning, by the artificial intelligence server, the second voice data corresponding to the specific sentence.
